(19) United States
(12) Patent Application Publication
(10) Pub. No.: US 2015/0042458 A1
(43) Pub. Date: Feb. 12, 2015

(54) RFID READER AND CONTROL METHOD

(71) Applicant: Wistron NeWeb Corp., Hsinchu (TW)

(72) Inventor: Yi-Ting TING, Hsinchu (TW)

(73) Assignee: Wistron NeWeb Corp., Hsinchu (TW)

(21) Appl. No.: 14/061,156

(22) Filed: Oct. 23, 2013

(30) Foreign Application Priority Data
Aug. 6, 2013 (TW) 102128053

(51) Int. Cl. G06K 7/10

(52) U.S. Cl. CPC G06K 7/10227
USPC 340/10.5; 235/439

(57) ABSTRACT

An RFID reader includes an antenna, a conversion unit, a lookup table, a storage unit, an identification unit and a processing unit. The antenna receives a first signal from an RFID tag. The conversion unit converts the first signal to a first serial number. The lookup table records a plurality of specific serial numbers and a plurality of storage locations of a plurality of application programs, each of the specific serial numbers corresponds to the storage location of one of the application programs. The identification unit determines whether the first serial number is one of the specific numbers. The processing unit enables the RFID reader to provide a first function if the first serial number is one of the specific serial numbers. If not, the processing unit enables the RFID reader to provide a second function different from the first function.

### CROSS REFERENCE TO RELATED APPLICATIONS

This Application claims priority of Taiwan Patent Application No. 102128053, filed on Aug. 6, 2013, the entirety of which is incorporated by reference herein.

### BACKGROUND OF THE INVENTION

1. Field of the Invention

The present invention relates to a radio-frequency identification (RFTD) read and in particular relates to an RFID reader controlled by an RFID tag.

2. Description of the Related Art

The application of RFID systems has recently been widely adopted, such as in door-access management or product management. In the current application, the user usually needs to use another computer to connect to the RFID reader by a network or transmission line (e.g. RS232 cable) in order to control or manage the RFID reader (such as storing back up data, or restoring the RFID reader to the default state). However, the environment of some RFID readers does not allow (or makes it inconvenient for) the user to connect to the RFID reader by the computer through the network or over the transmission line. In order to enable the user to control the RF reader more easily, the current control methods of the RFID readers need to improve.

### BRIEF SUMMARY OF THE INVENTION

A detailed description is given in the following embodiments with reference to the accompanying drawings.

A radio-frequency identification (RFID) reader is disclosed. The RFID reader includes an antenna, a conversion unit, a lookup table, a storage unit, an identification unit and a processing unit. The antenna is configured to transmit an RF signal to an RFID tag, and receive a first signal from the RFID tag. The conversion unit is configured to convert the first signal to a first serial number. The lookup table is configured to record a plurality of specific serial numbers and a plurality of storage locations of a plurality of application programs, wherein each of the specific serial numbers corresponds to one of the storage locations of the application programs. The storage unit includes a function library is configured to store the application programs; and a database is configured to store the first serial number. The identification unit is configured to determine whether the first serial number is one of the specific serial numbers. The processing unit is configured to, when the first number is one of the specific serial numbers, obtain a first storage location of a first application program corresponding to the first serial number according to the lookup table and load and perform the first application program corresponding to the first serial number from the function library according to the first storage location to enable the RFID reader to provide a first function. The processing unit enables the RFID reader to provide a second function when the identification unit determines the first serial number does not match with anyone of the specific serial numbers, and the first function is different from the second function.

A control method is disclosed. The control method is suitable for an RFID reader. The control method includes sending an RF signal to an RFID tag; receiving a first signal from the RFID tag; converting the first signal to a first serial number; determining whether the first serial number is one of a plurality of specified serial numbers; when the first serial number is one of the specific serial numbers, loading and performing a first application program from a function library according to a first storage location of the first application program corresponding to the first serial number, such that the RFID reader is enabled to provide a first function; and when the first serial number does not match with any one of the specific serial numbers, enabling the RFID reader to provide a second function, wherein the first function is different from the second function.

### BRIEF DESCRIPTION OF THE DRAWINGS

The present invention can be more fully understood by reading the subsequent detailed description and examples with references made to the accompanying drawings, wherein:

FIG. 1 is the schematic diagram of an RFID system according to one embodiment of the present invention;

FIG. 2 is another schematic diagram of the RFID reader according to one embodiment of the present invention;

FIG. 3 is the lookup table according to one embodiment of the present invention; and

FIG. 4 is the flowchart of the operation of the RFID reader according to the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

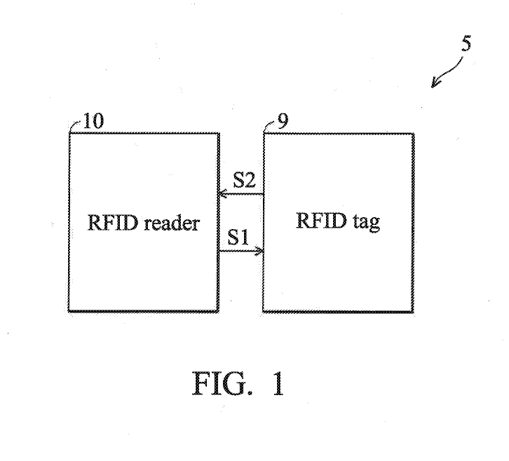

FIG. 1 is a schematic diagram of a radio-frequency identification (RFID) system according to one embodiment of the present invention. As shown in FIG. 1, an RFID system 5 includes an RFID reader 10, and an RFID tag 9, but it is not limited thereto. In one embodiment, the RFID reader 10 can be a stationary RFID reader, a portable RFID reader or a hand-held RFID reader, but it is not limited thereto. In the present embodiment, the RFID reader 10 is configured to transmit a radio-frequency (RF) signal S1 to the RFID tag 9 and to receive a first signal S2 from the RFID tag 9. In one embodiment, the frequency of the RF signal S1 and the frequency of the first signal S2 are not the same because of preventing the interference between the RF signals S1 and the first signal S2, but it is not limited thereto. The communication distance between the RFID reader 10 and the RFID tag 9 can be less than 10 cm, less than one meter, less than two meters or less than 100 meters, but it is not limited thereto.

In the present embodiment, the RFID tag 9 is an active RFID tag or a passive RFID tag. In the present embodiment, the RFID tag 9 has an antenna for receiving the RF signal S1 from the RFID reader 10, and responding with a first signal S2 to the RFID reader 10 according to the RF signal S1. In the present embodiment, the first signal S2 at least includes the serial number of the RFID tag 9.

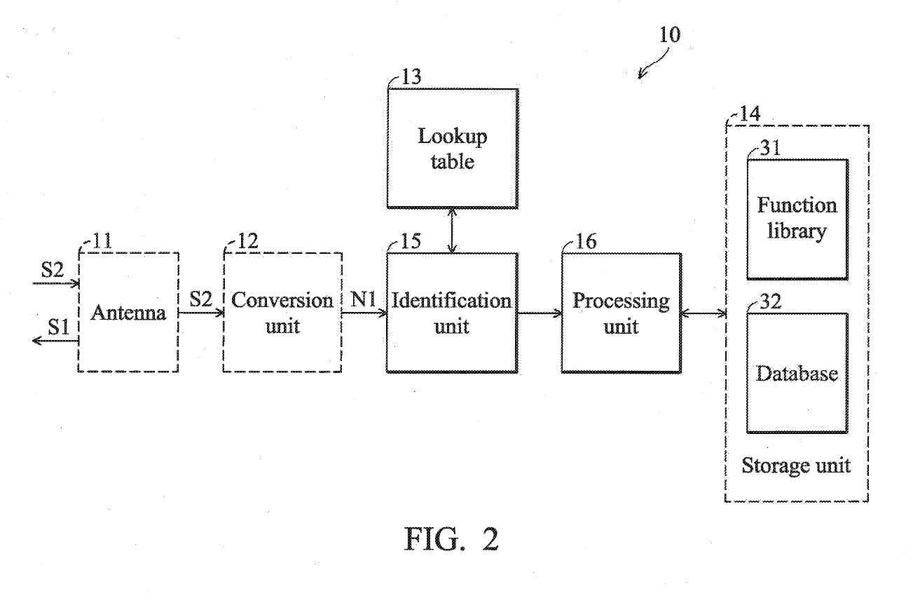

FIG. 2 is a schematic diagram of the RFID reader according to one embodiment of the present invention. As shown in FIG. 2, the RFID reader 10 includes an antenna 11, a conversion unit 12, a lookup table 13, a storage unit 14, an identification unit 15, and a processing unit 16. In one embodiment, the antenna 11, the conversion unit 12, the lookup table 13, the storage unit 14, the identification unit 15, and the processing unit 16 are connected together via a bus, but it is not limited thereto. The antenna 11 transmits the RF signals S1, and receives the first signal S2 from h RFID tag 9. In one embodiment, the first signal S2 received by the antenna 11 at least includes the serial number of the RFID tag 9.

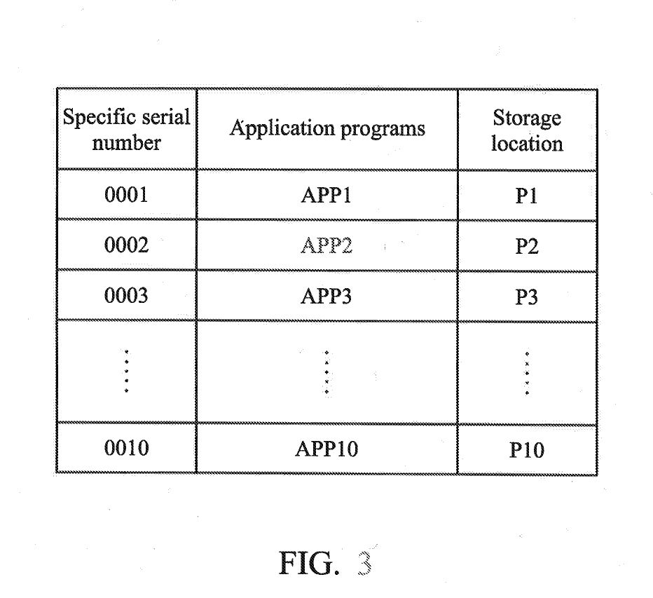

The conversion unit 12 is configured to convert the first signal S2 received by the antenna 11 to the first serial number N1. For example, the conversion unit 12 can be an analog-to-digital converter (ADC), a codec, or a combination thereof, but it is not limited thereto. The lookup table 13 is configured to record a plurality of specific serial numbers, a plurality of application programs corresponding to the specific serial numbers, and the storage locations of the application programs, but it is not limited thereto. FIG. 3 is a lookup table 13 showing the relationship among the specific serial number, application programs, and storage location. As shown in FIG. 3, the lookup table 13 records specific serial numbers from 0001, 0002 to 0010, application programs corresponding to the specific serial numbers, and storage locations of the application programs. For example, the specific serial number 0001 in the lookup table 13 corresponds to the application program APP1 and the storage location P1 of the application program APP1, and the specific serial number 0002 corresponds to the application program APP2 and the storage location P2 of the application program APP2, and so on.

Please refer to FIG. 2. The storage unit 14, which is configured to store the application programs and data performed by the processing unit 16, can be the read only memory (ROM), flash memory (flash ROM) and/or random access memory (RAM), but it is not limited thereto. In the present embodiment, the storage unit 14 includes a function library 31, and a database 32, but it is not limited thereto. The function library 31 is configured to store the application programs. For example, the application programs APP1-APP10 of the lookup table 13 are stored in the function library 31, and the storage locations P1-P10 of the lookup table 13 record the locations of the application programs APP1-APP10 in the function library 31.

In the present embodiment, the database 32 is configured to store data. For example, the database 32 stores the first serial number N1, but it is not limited thereto. In another embodiment, the database 32 can be configured to store the time when the RFID reader 10 reads the RFID tag 9, but it is not limited thereto.

The identification unit 15 is configured to determine whether the first serial number N1 converted by the conversion unit 12 is one of the specific serial numbers recorded in the lookup table 13. For example, when the first serial number N1 is 0003, the identification unit 15 determines that the first serial number N1 (0003) is one of the specific serial numbers recorded in the lookup table 13. In another embodiment, when the first number N1 is 0015 and the lookup table 13 does not record the serial number 0015, such that the identification unit 15 determines that the first serial number N1 (0015) does not match with any one of the specific serial numbers. In one embodiment, the identification unit 15 also determines whether the first serial number N1 (e.g. serial number 0003) is repeatedly read within a predetermined time (e.g. one second). When the first serial number N1 is repeatedly read within the predetermined time, the repeated first serial number N1 will be ignored or the RFID reader generates an alarm sound to prevent the first serial number N1 from repeatedly being read, but it is not limited thereto.

The processing unit 16 includes a central-processing unit (CPU) or a plurality of parallel processing units in the parallel processing environment, but it is not limited thereto. In the present embodiment, when the identification unit 15 determines that the first serial number N1 is one of the specific serial numbers recorded in the lookup table 13, the processing unit 16 loads and performs the application program via the function library 31 according to the storage location of the application program corresponding to the first serial number N1 for providing a first function. In one embodiment, the application program includes the routines, program, object, component, etc., and is configured to control the operation of the RFID reader 10.

For example, when the first serial number N1 is 0003, the identification unit 15 determines that the first serial number N1 (0003) is one of the specific serial numbers recorded in the lookup table 13. Thus, the processing unit 16 can load and perform the application program APP3 via the function library 31 according to the storage location P3 of the application program APP3 corresponding to the first serial number N1 (0003). For example, the application program APP3 enables the first function provided by the RFID reader 10 to restore to the default state, and when the processing unit 16 loads and performs the application program APP3 from the function library 31, the RFID reader 10 will be restored to the default state. In another embodiment, the application program enables the first function provided by the RFID reader 10, such that the RFID reader 10 operates in a power saving mode, pause mode or debugging mode, but it is not limited thereto. In another embodiment, the application program enables the first function provided by the RFID reader 10, such that the RFID reader 10 is to be rebooted. In another embodiment, the application program enables the first function provided by the RFID reader 10 to back up the data stored in the database 32 to another database or to another memory, but it is not limited thereto. In another embodiment, the application program enables the first function provided by the RFID reader 10 to change the scanning frequency of the antenna 11 of the RFID reader 10, but it is not limited thereto.

In another embodiment, when the identification unit 15 determines that the number Ni does not match with any one of the specific serial numbers recorded in the lookup table 13, the processing unit 16 enables the RFID reader 10 to provide a second. function. in one embodiment, the second function is configured to store the first serial number in the database 31, but it is not limited thereto. In another embodiment, the second function is not only configured to store the first serial number in the database 31, but also to transmit the first serial number to a server, but it is not limited thereto. In one embodiment, the second function is configured to transmit the first serial number to the server, but it is not limited thereto.

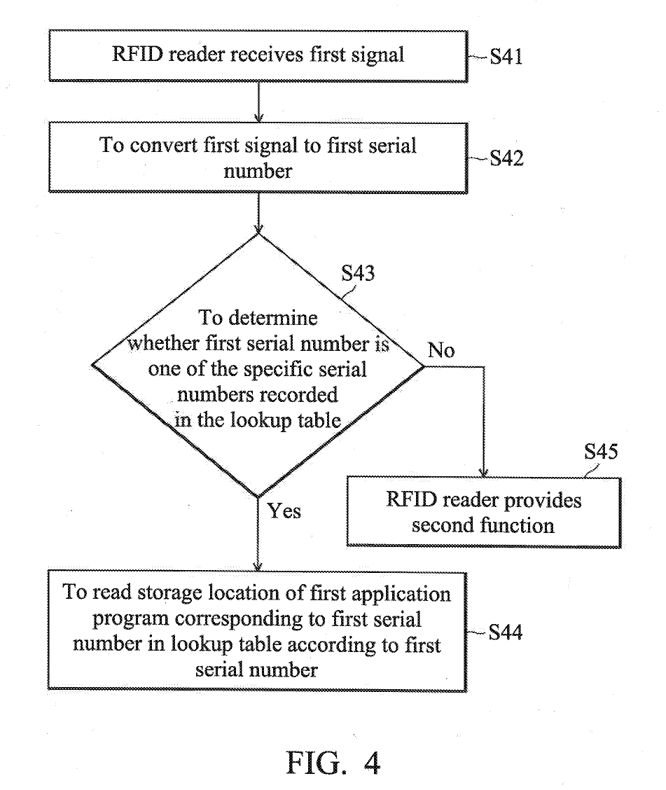

FIG. 4 is a flowchart of the control method according to the present invention. As shown in FIG. 4, the process begins at step S41, and the RFID reader 10 receives the first signal S2 via the antenna 11. In step 42, the conversion unit 12 converts the first signal S2 to the first serial number N1. For example, the conversion unit 12 converts the first signal S2 in analog format to the first serial number N1 in digital format, but it is not limited thereto. In step S43, the identification unit 15 determines whether the first serial number N1 is one of the specific serial numbers recorded in the lookup table 13. When the identification unit 15 determines that the first serial number N1 is one of the specific serial numbers recorded in the lookup table 13, the method goes to step S44. When the identification unit 15 determines that the first serial number N1 does not match with anyone of the specific serial numbers recorded in the lookup table 13, the method goes to step S45. In step S44, the processing unit 16 reads the storage location of the first application program corresponding to the first serial number N1 in the lookup table 13 according to the first serial number N1. The processing unit 16 then loads and performs the first application program from the function library 31 for enabling the RFID. reader 10 to provide the first function. For example, the first function provided by the first program corresponding to the first serial number N1 is configured to restore to the default state, and when the processing unit 16 loads and performs the first application program, the RFID reader 10 is restored to the default state. In step S45, the processing unit 16 enables the RFID reader 10 to provide the second function. For example, when the processing unit 16 determines that the first serial number N1 does not match with anyone of the specific numbers recorded in the lookup table 13, the processing unit 16 performs a default procedure, such that the RFID reader 10 is enabled to provide the second function. In another embodiment, when the identification unit 16 determines that the first number Ni does not match with anyone of the specific serial numbers recorded in the lookup table 13, the processing unit 16. stores the first serial number N1 in the database 32 (the second function), but it is not limited thereto.

Above all, the RF reader 10 of the present invention switches the functions thereof via the RFID tag 9 having a specific serial number without using a computer, network or cable.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A radio-frequency identification (RFID) reader, comprising:
an antenna, configured to transmit an RF signal to an RFID tag, and receive a first signal from the RFID tag;
a conversion unit, configured to convert the first signal to a first serial number;
a lookup table, configured to record a plurality of specific serial numbers and a plurality of storage locations of a plurality of application programs, wherein each of the specific serial numbers corresponds to one of the storage locations of the application programs;
a storage unit, comprising:
a function library, configured to store the application programs; and
a database, configured to store the first serial number;
an identification unit, configured to determine whether the first serial number is one of the specific serial numbers; and
a processing unit, configured to, when the first number is one of the specific serial numbers, obtain a first storage location of a first application program corresponding to the first serial number according to the lookup table and load and perform the first application program corresponding to the first serial number from the function library according to the first storage location to enable the RFID reader to provide a first function, wherein the processing unit enables the RFID reader to provide a second function when the identification unit determines the first serial number does not match with any one of the specific serial numbers, and the first function is different from the second function.

2. The RFID reader as claimed in claim 1, wherein the second function is configured to store the serial number in the database.

3. The RFID reader as claimed in claim 2, wherein the second function is further configured to transmit the first serial number to a server.

4. The RED reader as claimed in claim 1, wherein the first function is configured to restore the RFID reader to a default state, enable the RFID reader to operate in a power saving mode, a pause mode or a debug mode, reboot the RFID reader, or change a scanning frequency of the antenna.

5. The RFID reader as claimed in claim 1, wherein the first function is configured to back up the first serial number stored in the database to another database, and the second function is configured to store the first serial number to the database.

6. A control method, suitable for an RFID reader, the control method comprising:
sending a RF signal to an REI) tag;
receiving a first signal from the RFID tag;
converting the first signal to a first serial number;
determining whether the first serial number is one of a plurality of specified serial numbers;
when the first serial number is one of the specific serial numbers, loading and performing a first application program from a function library according to a first storage location of the first application program corresponding to the first serial number, such that the RFID reader is enabled to provide a first function; and
when the first serial number does not match with anyone of the specific serial numbers, enabling the RDID reader to provide a second function, wherein the first function is different from the second function.

7. The control method as claimed in claim 6, wherein the second function is configured to store the first serial number to a database.

8. The control method as claimed in claim 7, wherein the second function is further configured to send the first serial number to a server.

9. The control method as claimed in claim 6, wherein the first function is configured to restore the RFID reader to a default state, enable the RFID reader to operate in a power saving mode, a pause mode or a debug mode, reboot the RFID reader, or change a scanning frequency of the antenna.

10. The control method as claimed in claim 6, wherein the first function is configured to back up the first serial number stored in the database to another database, and the second function is configured to store the first serial number to the database.
